(19) United States
(12) Patent Application Publication
(10) Pub. No.: US 2023/0410685 A1
(43) Pub. Date: Dec. 21, 2023

(54) MULTIDIMENSIONAL DEMONSTRATION METHOD AND DEVICE FOR FERROFLUID

(71) Applicant: Chongqing Meisheng Technology Co., Ltd., Chongqing (CN)

(72) Inventors: Lei XIE, Chongqing (CN); Xunyong YANG, Chongqing (CN)

(21) Appl. No.: 18/335,445

(22) Filed: Jun. 15, 2023

(30) Foreign Application Priority Data
Jun. 15, 2022 (CN) 202210677998.3

(51) Int. Cl. G09B 23/18

(52) U.S. Cl. CPC G09B 23/181

(57) ABSTRACT

A multidimensional demonstration method and device for ferrofluid are provided. The device includes a container, a plurality of magnetic field generators, ferrofluid, and a transparent medium. The container is a closed structure with a hollow interior, and both the ferrofluid and the transparent medium are contained in the container. The container is a curved surface body with at least two planar outer walls, or a polyhedron, M magnetic field generators are installed on each at least two planar outer walls of the container, one side wall of a plurality of outer walls of the container without the magnetic field generators installed is set as an observation surface, the observation surface is made of a transparent material, where M is greater than or equal to 1. During operation, a magnetic field strength of the magnetic field generators is adjusted to control a motion of the ferrofluid in the container.

### CROSS REFERENCE TO RELATED APPLICATIONS

This application claims priority to and the benefit of Chinese Application No. 202210677998.3, filed Jun. 15, 2022; the contents of which as are hereby incorporated by reference in their entirety.

### BACKGROUND

### Technical Field

The present disclosure relates to a multidimensional demonstration method and device for ferrofluid.

### Description of Related Art

Due to its unique physical effects and artistic appearance, ferrofluids have attracted more and more attention, and have been developed into various art, entertainment, stress-reduction and fashion products. The magnetically controlled fluid morphology of ferrofluids is mapped with some object properties (such as decibel of signals of music and musical instruments) to achieve the visual presentation of the object properties, so as to achieve an artistic effect by using the fluid morphology of the ferrofluid. There is a ferrofluid music visual speaker, which combines the visual presentation of ferrofluid to music and the traditional audio functions. An electromagnet is integrated on the back of a container containing ferrofluid, and the magnetic field strength of the electromagnet is controlled by an audio signal, thus driving the dynamic flow of the ferrofluid.

The shortcomings of such a demonstration device are as follows: on the one hand, when the magnetic field frequency of the electromagnet on the back of the container changes too rapidly, the flow displacement of the aggregated ferrofluid in the fast response is small, i.e., the visualization effect for the fast-paced music is poor. On the other hand, when the electromagnet is only arranged behind (on the back of) a single plane, the ferrofluid only responds at or near the plane, and thus, the stereoscopic visual effect is limited.

To solve the above problems, it is necessary to develop a device and method capable of enabling ferrofluid to move on one plane or between/among multiple planes of a polyhedron.

### BRIEF SUMMARY

An objective of the present disclosure is to provide a multidimensional demonstration method and device for ferrofluid, so as to solve the problems in the prior art.

The technical solution adopted for achieving the objective of the present disclosure is as follows: A multidimensional demonstration device includes a container, multiple magnetic field generators, ferrofluid, and a transparent medium.

The container is a closed structure with a hollow interior, and both the ferrofluid and the transparent medium are contained in the container.

The container is a curved surface body with at least two planar outer walls or a polyhedron. M magnetic field generators are installed on each of at least two planar outer walls of the container, one side wall of the multiple outer walls of the container without the magnetic field generators installed is set as an observation surface, and the observation surfaces is made of a transparent material, where M is greater than or equal to 1.

During operation, a magnetic field strength of the magnetic field generator(s) is adjusted to control a motion of the ferrofluid in the container, and a user observes a motion trajectory of the ferrofluid through the observation surface.

Further, the planar outer walls of the container with the magnetic field generators installed border to each other.

Furthermore, when M is equal to 1, the motion trajectory of the ferrofluid crosses between inner walls corresponding to different outer planar walls of the container, or splits onto the inner walls corresponding to the different planar outer walls of the container. When M is greater than 1, the motion trajectory of the ferrofluid crosses between inner walls corresponding to different planar outer walls of the container, or splits onto the inner walls corresponding to different planar outer walls of the container, or moves on an inner wall corresponding to the same planar outer wall of the container.

Further, the container is of a rectangular cuboid structure. Further, the magnetic field generators are electromagnets.

A demonstration method based on the multidimensional demonstration device for ferrofluid above, wherein, during operation, adjusting the magnetic field strength of the magnetic field generators according to a time domain amplitude of an audio signal, and enabling the ferrofluid to move in the container under a change of a magnetic field.

A demonstration method based on the multidimensional demonstration device for ferrofluid above, wherein, during operation, framing an audio time domain signal to obtain a frequency spectrum, dividing the frequency spectrum into multiple segments, and adjusting the magnetic field strength of magnetic field generators according to a frequency spectrum amplitude at a segment, thus enabling the ferrofluid to move in the container under a change of a magnetic field.

A demonstration method based on the multidimensional demonstration device for ferrofluid above, wherein, during operation, setting, by a user, a periodic magnetic field signal, gradually increasing a magnetic field signal, and gradually decreasing the magnetic field signal, a step magnetic field signal and a pulse magnetic field signal; adjusting the magnetic field strength of the magnetic field generators according to a single signal or a combined magnetic field signal of at least two of these signals, thus enabling the ferrofluid to move in the container under a change of a magnetic field.

Further, the ferrofluid can perform an ordered cross-plane motion or random cross-plane motion between/among multiple inner walls of the container, or simultaneously move on two or more planes of the container.

Further, when M is greater than 1, the ferrofluid can perform an in-plane ordered motion or in-plane random motion on a set inner wall of the container.

There is no doubt about the technical effects of the present disclosure. One or more magnetic field generators are provided on multiple planes of the container of the device, such that the ferrofluid can move within one plane or between/among multiple planes of the polyhedron, thus achieving a more stereoscopic demonstration effect.

### BRIEF DESCRIPTION OF THE FIGURES

FIG. 1 is a schematic diagram of a device in accordance with an embodiment 1;

FIG. 2 is a ferrofluid motion trajectory of a device in accordance with an embodiment 1;

FIG. 3 is a schematic diagram of a device in accordance with an embodiment 2;

FIG. 4 is a ferrofluid motion trajectory of a device in accordance with an embodiment 2;

In the drawings: 1—container; 2—magnetic field generator; 3—ferrofluid; 4—transparent medium.

### DETAILED DESCRIPTION OF VARIOUS EMBODIMENTS

The present disclosure will be further described below with reference to embodiments, but it should not be understood that the scope of the subject of the present disclosure is merely limited to the following embodiments. Various replacements and alterations made according to the general technical knowledge and conventional means in the art without departing from the technical concept of the present disclosure shall fall into the protection scope of the present disclosure.

### Embodiment 1

It is provided a multidimensional demonstration device for ferrofluid according to this embodiment. The device includes a container 1, multiple magnetic field generators 2, ferrofluid 3, and a transparent medium 4.

The container 1 is a closed structure with a hollow interior, and both the ferrofluid 3 and the transparent medium 4 are contained in the container 1.

The container 1 is a curved surface body with at least two planar outer walls or a polyhedron. M magnetic field generators are installed on at least two planar outer walls of the container 1, one side wall of the multiple outer walls of the container 1 without the magnetic field generators 2 installed is set as an observation surface, the observation surface is made of a transparent material, where M is greater than or equal to 1.

The planar outer walls of the container 1 with the magnetic field generators 2 installed border to each other for the purpose of allowing the ferrofluid 3 to have a stronger magnetic force between adjacent planes with magnetic field generators to generate a cross-plane motion.

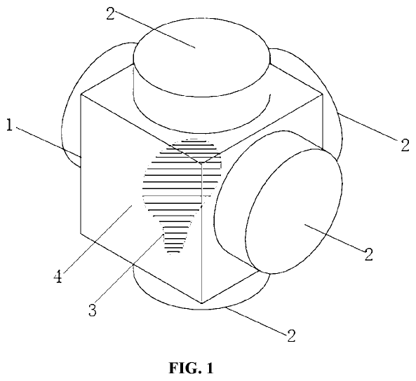

Referring to FIG. 1, in this embodiment, M is taken as 1, the container 1 is of a rectangular cuboid structure, the magnetic field generators 2 are circular electromagnets, and one magnetic field generator 2 is installed on each of the five planar outer walls of the rectangular cuboid structure.

During operation, a magnetic field strength of the magnetic field generators 2 is adjusted to control a motion of the ferrofluid 3 in the container 1, and a user can observe a motion trajectory and a morphology change of the ferrofluid 3 through the observation surface. The magnetic field strength of the magnetic field generators 2 is adjusted according to a time domain amplitude of an audio signal, for example, an output current or voltage is controlled through pulse width modulation to the electromagnets, such that the change of the motion morphology of the ferrofluid with the strength of audio time domain rhythm is achieved, and the user can observe the motion change of the ferrofluid 3 with the music rhythm. The device further includes an audio source analysis module. The audio source analysis module is used to obtain a frequency and amplitude of each frequency domain component of an input audio, and to output a motion lifting control signal. This embodiment can realize the real-time mapping of the magnetically controlled phase change appearance of the ferrofluid and the music rhythm, and achieve the integration of science and art.

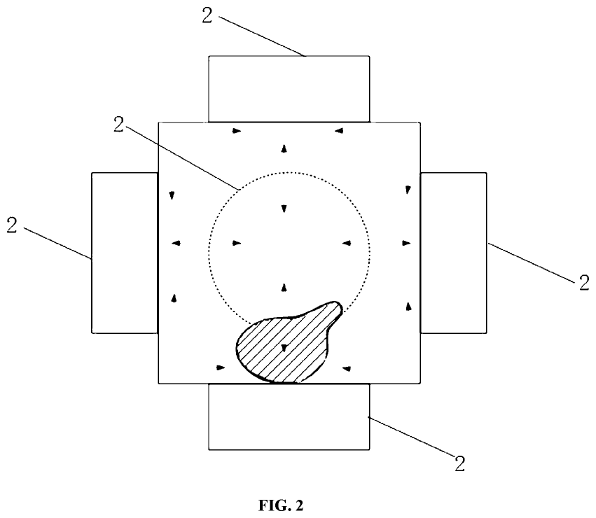

Referring to FIG. 2, the motion trajectory of the ferrofluid 3 crosses between inner walls corresponding to different planar outer walls of the container 1, or splits onto inner walls corresponding to different planar outer walls of the container 1.

In the actual control process, each planar outer wall of the container 1 can be numbered, and the ferrofluid 3 is controlled to perform a random cross-plane motion or ordered cross-plane motion among the numbered planar outer walls, where the ordered cross-plane motion includes clockwise, counterclockwise and other sequences.

When the ferrofluid 3 needs to be split onto the inner walls corresponding to the different planar outer walls, during the cross-plane process of the ferrofluid 3, the magnetic field generator on the former magnetic plane decreases its magnetic force, and the magnetic field generator on the latter magnetic plane increases its magnetic force. When part of the ferrofluid enters the latter magnetic plane (i.e., a whole cloud of ferrofluid is separated into two), both the magnetic field generator on the former magnetic plane and the magnetic field generator on the latter magnetic plane increase their magnetic force, such that a part of the ferrofluid is retained on each of the two magnetic planes, and simultaneous demonstration of the ferrofluids on two planes is achieved. By analogy, simultaneous demonstrations of the ferrofluids on more planes can be achieved.

The cross-plane motion of the ferrofluid is achieved by a switch control sequence of the magnetic field generators. That is, the motion of the ferrofluid from the former to the latter can be achieved when the magnetic field generator where the ferrofluid is currently located is turned off and the next magnetic field generator is turned on.

After each cross-plane motion, the ferrofluid stays in the magnetic plane for a certain time to demonstrate a time domain amplitude of an audio. After each in-plane motion, the ferrofluid stays on the position of the magnetic field generator for a certain time to demonstrate a time domain amplitude of the audio. The stay time may be a certain of set time, or a complete audio (such as a piece of music).

When a density of the ferrofluid 3 is less than that of the transparent medium 4 (the ferrofluid is suspended to the top when the device stands by), the ferrofluid does not stay on a bottom magnetic plane for demonstration, and preferentially stays on the top magnetic plane for demonstration.

When a density of the ferrofluid 3 is greater than that of the transparent medium 4 (the ferrofluid settles to the bottom when the device stands by), the ferrofluid does not stay on a top magnetic plane for demonstration, and preferentially stays on the bottom magnetic plane for demonstration.

When a density of ferrofluid 3 is equal to or close to that of the transparent medium 4, the ferrofluid can stay on each magnetic plane for demonstration.

### Embodiment 2

It is provided a multidimensional demonstration device for ferrofluid according to this embodiment. The device includes a container 1, multiple magnetic field generators 2, ferrofluid 3, and a transparent medium 4.

The container 1 is a closed structure with a hollow interior, and both the ferrofluid 3 and the transparent medium 4 are contained in the container 1.

The container 1 is a curved surface body with at least two planar outer walls or a polyhedron. M magnetic field generators are installed on each of at least two planar outer walls of the container 1, one side wall of multiple outer walls of the container 1 without the magnetic field generators 2 installed is set as an observation surface, the observation surface is made of a transparent material, where M is greater than or equal to 1. Further, planar outer walls of the container 1 with the magnetic field generators 2 installed border to each other.

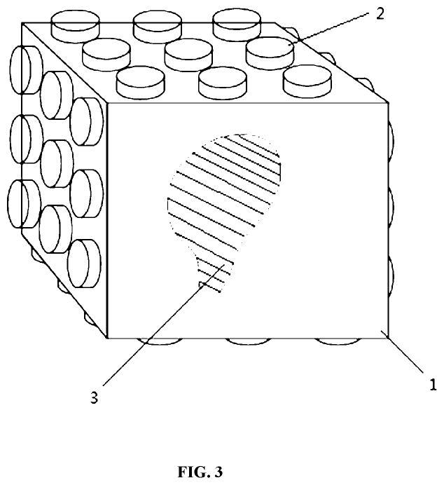

Referring to FIG. 3, in this embodiment, M is taken as 9, nine magnetic field generators 2 are arranged in a matrix on the same planar outer wall. The container 1 is of a rectangular cuboid structure, the magnetic field generators 2 are circular electromagnets, such that the ferrofluid 3 can move within the same magnetic plane besides cross-plane motion.

During operation, the magnetic field strength of the magnetic field generators 2 is adjusted to control a motion of the ferrofluid 3 in the container 1, and a user can observe a motion trajectory of the ferrofluid 3 through the observation surface. An audio time domain signal is framed to obtain a frequency spectrum, the frequency spectrum is divided into multiple segments, the magnetic field strength of the magnetic field generators 2 is adjusted according to a frequency spectrum magnitude of a segment, for example, an output current or voltage is controlled through pulse width modulation to the electromagnet, thus achieving the change of the motion morphology of the ferrofluid along with the audio frequency spectrum magnitude of this segment. Different demonstration effects can be obtained by selecting the frequency spectrums of different segments.

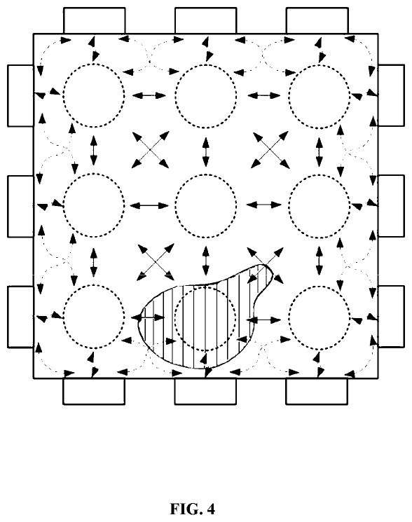

Referring to FIG. 4, the motion trajectory of the ferrofluid 3 crosses among inner walls corresponding to different planar outer walls of the container, or splits onto the inner walls corresponding to different planar outer walls of the container 1, or moves on an inner wall corresponding to the same planar outer wall of the container 1. A dashed arrow in the figure indicates a cross-plane motion, and a solid arrow indicates an in-plane motion.

In the actual control process, each planar outer wall of the container 1 can be numbered, and the ferrofluid 3 may be controlled to perform a random cross-plane motion or ordered cross-plane motion between/among the numbered planar outer walls, or the ferrofluid 3 may also be controlled to perform an in-plane random motion or in-plane ordered motion between/among in-plane magnetic field generators 2, where the in-plane ordered motion includes clockwise, counterclockwise, linear and other sequences.

### Embodiment 3

It is provided a multidimensional demonstration method for ferrofluid according to this embodiment. The method is based on the demonstration device of Embodiment 1, during operation, the magnetic field strength of a magnetic field generators 2 is adjusted according to a time domain amplitude of an audio signal. Ferrofluid 3, under the change of a magnetic field, performs an ordered cross-plane motion or random cross-plane motion between/among five inner walls of a container 1, or simultaneously moves on two or more planes of the container 1.

### Embodiment 4

It is provided a multidimensional demonstration method for ferrofluid according to this embodiment. The method is based on the demonstration device of Embodiment 2, during operation, the magnetic field strength of a magnetic field generators 2 is adjusted according to a time domain amplitude of an audio signal. Ferrofluid 3, under the change of a magnetic field, may perform an ordered cross-plane motion or random cross-plane motion between/among five inner walls of a container 1, may simultaneously move on two or more planes, or may perform an in-plane ordered motion or in-plane random motion on a set inner wall of the container 1.

### Embodiment 5

It is provided a multidimensional demonstration method for ferrofluid according to this embodiment. The method is based on the demonstration device of Embodiment 1, during operation, an audio time domain signal is framed to obtain a frequency spectrum, the frequency spectrum is divided into multiple segments, and the magnetic field strength of a magnetic field generators 2 is adjusted according to a time domain amplitude of a segment. Ferrofluid 3, under the change of a magnetic field, performs an ordered cross-plane motion or random cross-plane motion between/among five inner walls of a container 1, or simultaneously moves on two or more planes of the container 1.

### Embodiment 6

It is provided a multidimensional demonstration method for ferrofluid according to this embodiment. The method is based on the demonstration device of Embodiment 2, during operation, an audio time domain signal is framed to obtain a frequency spectrum, the frequency spectrum is divided into multiple segments, and the magnetic field strength of a magnetic field generators 2 is adjusted according to a time domain amplitude of a segment. Ferrofluid 3, under the change of a magnetic field, may perform an ordered cross-plane motion or random cross-plane motion between/among five inner walls of a container 1, may simultaneously move on two or more plane, or may perform an in-plane ordered motion or in-plane random motion on a set inner wall of the container 1.

### Embodiment 7

It is provided a multidimensional demonstration method for ferrofluid according to this embodiment. The method is based on the demonstration device of Embodiment 1, during operation, a user sets a periodic magnetic field signal, gradually increases a magnetic field signal, and gradually decreases the magnetic field signal, a step magnetic field signal and a pulse magnetic field signal. The magnetic field strength of a magnetic field generators 2 is adjusted according to a single signal or a combined magnetic field signal of at least two of these signals, and thus ferrofluid 3, under the change of a magnetic field, performs an ordered cross-plane motion or random cross-plane motion between/among five inner walls of a container 1, or simultaneously moves on two or more planes of the container 1.

### Embodiment 8

It is provided a multidimensional demonstration method for ferrofluid according to this embodiment. The method is based on the demonstration device of Embodiment 2, during operation, a user sets a periodic magnetic field signal, gradually increases a magnetic field signal, and gradually decreases the magnetic field signal, a step magnetic field signal and a pulse magnetic field signal. The magnetic field strength of a magnetic field generators 2 is adjusted according to a single signal or a combined magnetic field signal of at least two of these signals, and thus ferrofluid 3, under the change of a magnetic field, may perform an ordered cross-plane motion or random cross-plane motion between/among five inner walls of a container 1, may simultaneously move on two or more planes, or may perform an in-plane ordered motion or in-plane random motion on a set inner wall of the container 1.

### Embodiment 9

It is provided a multidimensional demonstration device for ferrofluid according to this embodiment. The device includes a container 1, multiple magnetic field generators 2, ferrofluid 3, and a transparent medium 4.

The container 1 is a closed structure with a hollow interior, and both the ferrofluid 3 and the transparent medium 4 are contained in the container 1.

The container 1 is a curved surface body with at least two planar outer walls or a polyhedron. M magnetic field generators 2 are installed on each of at least two planar outer walls of the container 1, one side wall of multiple outer walls of the container 1 without the magnetic field generators 2 installed is set as an observation surface, the observation surface is made of a transparent material, where M is greater than or equal to 1.

During operation, the magnetic field strength of the magnetic field generators 2 is adjusted to control a motion of the ferrofluid 3 in the container 1, and a user can observe a motion trajectory of the ferrofluid 3 through the observation surface.

### Embodiment 10

A main structure of this embodiment is the same as that of Embodiment 9, further, the planar outer walls of the container 1 with the magnetic field generators 2 installed border to each other.

### Embodiment 11

A main structure of this embodiment is the same as that of Embodiment 9, further, when M is equal to 1, the motion trajectory of the ferrofluid 3 crosses between/among inner walls corresponding to different plane outer walls of the container 1, or splits onto the inner walls corresponding to different plane outer walls of the container 1. When M is greater than 1, the motion trajectory of the ferrofluid 3 crosses between/among inner walls corresponding to different planar outer walls of the container 1, or splits onto the inner walls corresponding to different planar outer walls of the container 1, or moves on an inner wall corresponding to the same planar outer wall of the container 1.

### Embodiment 12

A main structure of this embodiment is the same as that of Embodiment 9, further, the container 1 is of a rectangular cuboid structure.

### Embodiment 13

A main structure of this embodiment is the same as that of Embodiment 9, further, the magnetic field generators 2 are electromagnets, and the electromagnets are circular or bar shaped.

1-10. (canceled)

11. A multidimensional demonstration device for ferrofluid, comprising a container (1), a plurality of magnetic field generators (2), ferrofluid (3), and a transparent medium (4);
the container (1) is a closed structure with a hollow interior, and both the ferrofluid (3) and the transparent medium (4) are contained in the container (1);
the container (1) is a curved surface body with at least two planar outer walls, or a polyhedron, M magnetic field generators are installed on each of the at least two planar outer walls of the container (1), one side wall of a plurality of outer walls of the container (1) without the magnetic field generators (2) installed is set as an observation surface, the observation surface is made of a transparent material, where M is greater than or equal to 1;
during operation, a magnetic field strength of the magnetic field generators (2) is adjusted to control a motion of the ferrofluid (3) in the container (1), and a user observes a motion trajectory of the ferrofluid (3) through the observation surface.

12. The multidimensional demonstration device for ferrofluid according to claim 11, wherein the planar outer walls of the container (1) with the magnetic field generators (2) installed border to each other.

13. The multidimensional demonstration device for ferrofluid according to claim 11, wherein when M is equal to 1, the motion trajectory of the ferrofluid (3) crosses between inner walls corresponding to different outer planar walls of the container (1), or splits onto the inner walls corresponding to the different planar outer walls of the container (1); when M is greater than 1, the motion trajectory of the ferrofluid (3) crosses between inner walls corresponding to different planar outer walls of the container (1), or splits onto the inner walls corresponding to different planar outer walls of the container (1), or moves on an inner wall corresponding to the same planar outer wall of the container (1).

14. The multidimensional demonstration device for ferrofluid according to claim 12, wherein when M is equal to 1, the motion trajectory of the ferrofluid (3) crosses between inner walls corresponding to different outer planar walls of the container (1), or splits onto the inner walls corresponding to the different planar outer walls of the container (1); when M is greater than 1, the motion trajectory of the ferrofluid (3) crosses between inner walls corresponding to different planar outer walls of the container (1), or splits onto the inner walls corresponding to different planar outer walls of the container (1), or moves on an inner wall corresponding to the same planar outer wall of the container (1).

15. The multidimensional demonstration device for ferrofluid according to claim 11, wherein the container (1) is of a rectangular cuboid structure.

16. The multidimensional demonstration device for ferrofluid according to claim 13, wherein the container (1) is of a rectangular cuboid structure.

17. The multidimensional demonstration device for ferrofluid according to claim 14, wherein the container (1) is of a rectangular cuboid structure.

18. The multidimensional demonstration device for ferrofluid according to claim 11, wherein the magnetic field generators (2) are electromagnets.

19. A demonstration method based on the multidimensional demonstration device for ferrofluid according to claim 11, wherein, during operation, adjusting a magnetic field strength of the magnetic field generators (2) according to a time domain amplitude of an audio signal, and enabling the ferrofluid (3) to move in the container (1) under a change of magnetic field.

20. A demonstration method based on the multidimensional demonstration device for ferrofluid according to claim 11, wherein, during operation, framing an audio time domain signal to obtain a frequency spectrum, dividing the frequency spectrum into a plurality of segments, and adjusting a magnetic field strength of the magnetic field generators (2) according to a frequency spectrum amplitude at a segment, thus enabling the ferrofluid (3) to move in the container (1) under a change of a magnetic field.

21. A demonstration method based on the multidimensional demonstration device for ferrofluid according to claim 11, wherein, during operation, setting, by a user, a periodic magnetic field signal, gradually increasing a magnetic field signal, and gradually decreasing the magnetic field signal, a step magnetic field signal and a pulse magnetic field signal; adjusting a magnetic field strength of the magnetic field generators (2) according to a single signal or a combined magnetic field signal of at least two of the signals, thus enabling the ferrofluid (3) to move in the container (1) under a change of magnetic field.

22. The demonstration method for the multidimensional demonstration device for ferrofluid according to claim 19, wherein the ferrofluid (3) is also capable of performing an ordered cross-plane motion or random cross-plane motion between/among a plurality of inner walls of the container (1), or simultaneously moving on two or more planes of the container (1).

23. The demonstration method for the multidimensional demonstration device for ferrofluid according to claim 20, wherein the ferrofluid (3) is also capable of performing an ordered cross-plane motion or random cross-plane motion between/among a plurality of inner walls of the container (1), or simultaneously moving on two or more planes of the container (1).

24. The demonstration method for the multidimensional demonstration device for ferrofluid according to claim 21, wherein the ferrofluid (3) is also capable of performing an ordered cross-plane motion or random cross-plane motion between/among a plurality of inner walls of the container (1), or simultaneously moving on two or more planes of the container (1).

25. The demonstration method for the multidimensional demonstration device for ferrofluid according to claim 19, wherein when M is greater than 1, the ferrofluid (3) is capable of performing an in-plane ordered motion or in-plane random motion on a set inner wall of the container (1).

26. The demonstration method for the multidimensional demonstration device for ferrofluid according to claim 20, wherein when M is greater than 1, the ferrofluid (3) is capable of performing an in-plane ordered motion or in-plane random motion on a set inner wall of the container (1).

27. The demonstration method for the multidimensional demonstration device for ferrofluid according to claim 21, wherein when M is greater than 1, the ferrofluid (3) is capable of performing an in-plane ordered motion or in-plane random motion on a set inner wall of the container (1).
